(19) United States
(12) Patent Application Publication
(10) Pub. No.: US 2025/0356818 A1
(43) Pub. Date: Nov. 20, 2025

(54) DATA DRIVING APPARATUS FOR DRIVING PIXEL OF DISPLAY PANEL

(71) Applicant: LX SEMICON CO., LTD., Daejeon (KR)

(72) Inventors: Won KIM, Daejeon (KR); Se Hong OH, Daejeon (KR); Beom Rak CHOI, Daejeon (KR)

(73) Assignee: LX SEMICON CO., LTD., Daejeon (KR)

(21) Appl. No.: 19/125,809

(22) PCT Filed: Jun. 28, 2023
(86) PCT No.: PCT/KR2023/009007

§ 371 Date: Apr. 30, 2025

(30) Foreign Application Priority Data
Oct. 31, 2022 (KR) 10-2022-0142744

(51) Int. Cl. G09G 3/36; G09G 3/3233; G09G 3/34

(52) U.S. Cl. CPC G09G 3/3607; G09G 3/3426; G09G 3/3233; G09G 2300/0861; G09G 2310/027; G09G 2310/0286; G09G 2310/06; G09G 2320/0233; G09G 2320/0673; G09G 2330/06; G09G 2330/08

(57) ABSTRACT

A data driving apparatus includes a latch circuit that stores pixel image data representing a gray value of a pixel, a digital-to-analog converting circuit that converts, into an analog signal, a digital signal corresponding to the pixel image data by using gamma voltages; a buffer circuit that includes an input switch for controlling a connection with the digital-to-analog converting circuit and transmits, to the pixel, an analog signal for driving the pixel; and an output switch that controls a connection between the buffer circuit and a data line connected to the pixel, wherein, when the digital-to-analog converter converts a digital signal for a gray value into an analog signal, the digital-to-analog converting circuit delays the analog signal and inputs the analog signal to the buffer circuit to block occurring noise from propagating to the pixel.

### CROSS-REFERENCE TO RELATED APPLICATIONS

This application is a national phase entry of PCT International Application No. PCT/KR2023/009007 filed on Jun. 28, 2023, which claims the priority of Korean Application No. 10-2022-0142744 filed on Oct. 31, 2022, which are hereby incorporated by reference in their entirety.

### BACKGROUND

### Field of the Disclosure

The present disclosure relates to a data driving apparatus for driving pixels of a display panel.

### Description of the Background

A plurality of pixels may be arranged on a display panel. The pixels may control brightness using a backlight and a liquid crystal, and may control brightness by controlling the amount of power flowing to a self-luminous element such as an Organic Light Emitting Diode (OLED).

The display device may include a driving apparatus capable of controlling the brightness of each pixel. The driving apparatus may control the brightness of each pixel by controlling the degree of opening and closing of the liquid crystal or controlling the amount of power supplied to the self-luminous element.

The driving apparatus may supply a data voltage corresponding to the grayscale value of each pixel to each pixel. And, each pixel may control the degree of opening and closing of the liquid crystal or control the amount of current supplied to the self-luminous element according to the data voltage. In terms of supplying the data voltage, the aforementioned driving device is also called a data driving device. Meanwhile, a driving transistor may be arranged in each pixel, and the data voltage may be supplied to the source terminal of the driving transistor. In this respect, the data driving device is also called a source driver. In addition, the data driving device may drive multiple pixels in which one channel constitutes one vertical line. In this respect, the data driving device is also called a column driver.

The data driving device may drive one line per horizontal line at a predetermined horizontal time. For example, the data driving device may drive the pixels of the first horizontal line during the first horizontal time, and drive the pixels of the second horizontal line during the second horizontal time following the first horizontal time.

The data driving device may change the size of the data voltage supplied to the display panel according to the grayscale value of each line pixel at one point in time for each horizontal time. For example, the data driving device may supply the first data voltage to the display panel during the first horizontal time, and then change the first data voltage to the second data voltage and supply it to the display panel at the start of the second horizontal time.

The power consumption of the data driving device may increase significantly mainly during the process of changing the data voltage. However, since this increase occurs instantaneously, noise due to instantaneous power consumption may occur in the data driving device. This noise may be transmitted along the ground, and since most of the components constituting the display device share the ground, this noise may be a serious factor causing a defect in the display device.

Against this backdrop, the present aspect is, in one aspect, to provide a technology for minimizing the occurrence of the aforementioned noise or reducing the intensity of the aforementioned noise. In another aspect, the present aspect is to provide a technology for blocking or minimizing the propagation of the aforementioned noise.

To achieve the aforementioned, the present disclosure provides a data driving device including a latch circuit configured to store pixel image data; a digital-to-analog converting circuit configured to convert a digital signal corresponding to the pixel image data into an analog signal; a buffer circuit including an input switch controlling connection with the digital-to-analog converting circuit and configured to transmit the analog signal to a pixel; and an output switch configured to control connection between a data line connected to the pixel and the buffer circuit.

In another aspect, the present disclosure provides a data driving device including a digital-to-analog converting circuit configured to convert a digital signal for a grayscale value into an analog signal for driving a pixel; and a buffer circuit configured to delay the analog signal by a predetermined time and amplify the analog signal delayed by the predetermined time and transmit the amplified analog signal to the pixel.

As described above, according to the present aspect, the occurrence of noise due to instantaneous power consumption may be minimized or the intensity of such noise may be reduced. In addition, according to the present aspect, the propagation of such noise may be blocked or minimized. In addition, according to the present aspect, the influence of such noise may be minimized to minimize defects in the display device, particularly, poor image quality.

### BRIEF DESCRIPTION OF THE DRAWINGS

FIG. 1 is a configuration diagram of a display device according to one aspect of the present disclosure.

FIG. 2 is a configuration diagram of a data driving device according to one aspect.

FIG. 3 is a diagram for explaining noise that may appear in the first mode.

FIG. 4 is a drawing for explaining noise that may appear when there is no input switch in the second mode.

FIG. 5 is a drawing illustrating a first example of a buffer circuit according to one aspect.

FIG. 6 is a drawing illustrating the main waveforms of the first example shown in FIG. 5.

FIG. 7 is a drawing illustrating a second example of a buffer circuit according to one aspect.

FIG. 8 is a drawing illustrating the main waveforms of the second example shown in FIG. 7.

### DETAILED DESCRIPTION

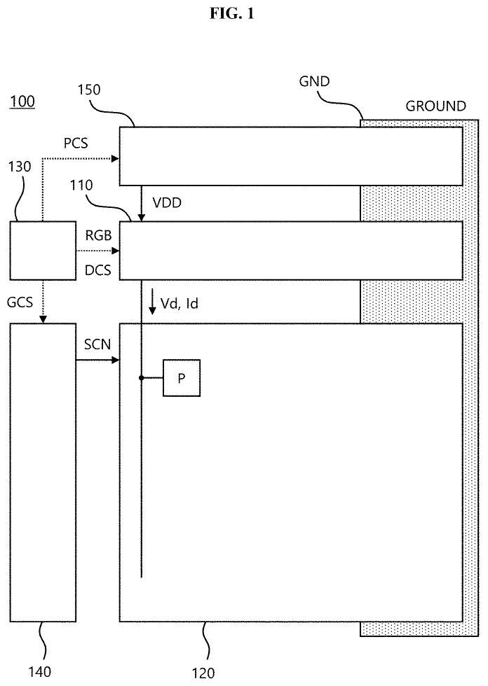

FIG. 1 is a configuration diagram of a display device according to one aspect of the present disclosure.

Referring to FIG. 1, the display device 100 may include a display panel 120, a data processing device 130, a gate driving device 140, a data driving device 110, and a power management device 150.

The display panel 120 may be a liquid crystal display (LCD) panel, or may be a self-luminous element panel such as an organic light emitting diode (OLED) panel.

When the display panel 120 is a liquid crystal display panel, the display panel 120 may include a backlight, a liquid crystal, and a common electrode, and a pixel electrode and a driving transistor may be arranged in each pixel. When a scan signal is supplied to the gate of the driving transistor, the driving transistor is turned on and the data voltage may be supplied to the pixel electrode. Then, depending on the data voltage, an electric field is formed between the pixel electrode and the common electrode, and the alignment direction of the liquid crystal changes, and accordingly, the transmittance of light supplied from the backlight changes, and the brightness of the pixel may be adjusted.

A plurality of data lines and a plurality of gate lines may be arranged in a matrix form on the display panel 120. The data line may be connected to the source terminal of the driving transistor of each pixel, and the gate line may be connected to the gate terminal of the driving transistor of each pixel. When a scan signal is supplied to the gate line, the driving transistor is turned on and the data voltage supplied through the data line may be transmitted to the pixel electrode.

A parasitic capacitor may be formed on the data line. The parasitic capacitor may be formed between the data line and the common electrode or between the data line and the pixel electrode. From the standpoint of the data driving device 110 that supplies the data voltage, the parasitic capacitor may be recognized as a load. The larger the capacity of the parasitic capacitor, the more power the data driving device 110 must supply to the data line.

The display panel 120 may be a self-luminous element panel such as an OLED panel. In addition to the OLED panel, the self-luminous element panel may also use other types of self-luminous elements such as a micro LED panel.

A scan transistor, a driving transistor, and an OLED may be arranged in each pixel of the OLED panel. When a scan signal is supplied to the gate of the scan transistor, the scan transistor is turned on and the data voltage may be supplied to the driving transistor through the scan transistor. In the OLED panel, the data voltage may be supplied to the gate of the driving transistor. The size of the conduction current of the driving transistor is determined according to the size of the data voltage, and the brightness of the OLED connected to the driving transistor may be adjusted according to the size of the conduction current of the driving transistor.

A plurality of data lines and a plurality of gate lines may be arranged in a matrix form on the display panel 120. The data line may be connected to the source terminal of the scan transistor of each pixel, and the gate line may be connected to the gate terminal of the source transistor of each pixel. When a scan signal is supplied to the gate line, the scan transistor is turned on, and the data voltage supplied through the data line may be transmitted to the driving transistor.

A parasitic capacitor may be formed on the data line. The parasitic capacitor may be formed between the data line and the cathode electrode of the OLED, or between the data line and the anode electrode of the OLED. From the perspective of the data driving device 110 that supplies the data voltage, the parasitic capacitor may be recognized as a load. The larger the capacity of the parasitic capacitor, the more power the data drive device 110 must supply to the data line.

The data processing device 130 may receive image data from an external device—for example, a host or a device called an AP (Application Processor). Then, the image data in the format of the external device may be converted into image data (RGB) in a format that the data drive device 110 may process. Then, the data processing device 130 may transmit the converted image data (RGB) to the data drive device 110.

The image data (RGB) may include pixel image data representing a grayscale value for each pixel. The pixel image data for one pixel may be, for example, data having 8 bits and may express a grayscale value from 0 to 255. The data processing device 130 may generate pixel image data for each pixel and transmit the pixel image data to the data driving device 110 by including the pixel image data in the image data (RGB).

The data processing device 130 may transmit control signals to devices involved in driving the display panel—for example, the data driving device 110, the gate driving device 140, and the power management device 150. The data processing device 130 may transmit a data control signal (DCS) to the data driving device 110, a gate control signal (GCS) to the gate driving device 140, and a power control signal (PCS) to the power management device 150.

The control signals (DCS, GCS, PCS) may include setting information for each device. For example, the data processing device 130 may receive setting information from an external device, check the setting information for each device, and then transmit the setting information by including it in the corresponding control signal (DCS or GCS or PCS).

The control signals (DCS, GCS, PCS) may include a timing signal for controlling each device. The timing signal may be, for example, a vertical synchronization signal (Vsync), a horizontal synchronization signal (Hsync), etc. The data driving device 110, the gate driving device 140, or the power management device 150 may distinguish frames according to the timing signal and distinguish each horizontal time. In terms of controlling the timing of each device, the data processing device 130 is also called a timing controller.

The gate driving device 140 may supply a scan signal (SCN) to pixels (P) arranged on the display panel 120. And, pixels supplied with a scan signal (SCN) indicating a turn-on are selected, and data voltage may be supplied to the selected pixels.

The gate driving device 140 may supply a scan signal (SCN) through a gate line. A plurality of gate lines may be arranged on the display panel 120. And, each gate line may be connected to pixels arranged in a row in one direction—for example, a horizontal direction. The gate driving device 140 may supply a scan signal (SCN) indicating a turn-on to one of the plurality of gate lines, and pixels connected to the corresponding gate line may be selected. The gate driving device 140 may supply a scan signal (SCN) indicating a turn-on while changing the gate line at each time interval.

The power management device 150 may supply power to each device constituting the display device 100. For example, the power management device 150 may supply a driving voltage to the data processing device 130, the gate driving device 140, and the data driving device 110. Each device may drive its internal circuits using this driving voltage.

The power management device 150 may supply power for driving pixels to the necessary portion. For example, when the display panel 120 is a liquid crystal display panel, the power management device 150 may supply a common voltage to a common electrode arranged on the display panel 120, and may supply a driving voltage (VDD) to the data driving device 110 so that the data voltage is supplied to the pixel electrode.

The data driving device 110 may drive pixels (P) arranged on the display panel 120.

The data driving device 110 may receive image data (RGB) from the data processing device 130. Then, the data driving device 110 may check the pixel image data for each pixel (P) included in the image data (RGB) and generate a data voltage (Vd) corresponding to the pixel image data and supply it to each pixel (P).

The pixel image data may represent a grayscale value for each pixel (P), and the data driving device 110 may generate a data voltage (Vd) corresponding to the grayscale value.

The pixel image data may be stored in the latch circuit of the data driving device 110 and then output in the form of a digital signal. Then, the data driving device 110 may convert the digital signal into an analog signal using gamma voltages.

There is a difference between the grayscale corresponding to physical brightness and the grayscale corresponding to brightness perceived by humans. Compensating for this difference is called gamma conversion. When the data drive device 110 converts a digital signal to an analog signal, it may simultaneously apply gamma conversion. For example, the data drive device 110 may simultaneously apply digital-to-analog conversion and gamma conversion by using the voltages used for digital-to-analog conversion as voltages to which gamma conversion is applied—gamma voltages.

The analog signal may not be suitable for driving the pixel (P) because of its low power level. Therefore, the data drive device 110 may amplify the analog signal to generate a data voltage (Vd) and supply the data voltage (Vd) with a relatively high power level to the pixel (P).

When the data voltage (Vd) is supplied, the data current (Id) flows accordingly, and the size of the data current (Id) may vary depending on the state of the load. The load recognized by the data drive device 110 may mostly be a capacitive load. From the perspective of the data drive device 110, the pixel (P) is also a capacitive load, and the parasitic capacitor of the data line connected to the pixel (P) may also be a capacitive load.

In the case of a capacitive load, the size of the data current (Id) may vary depending on the difference between the voltage of the previous state and the voltage to be currently supplied. When the voltage difference is large, the data current (Id) flows a lot, and when the voltage difference is small, the data current (Id) flows a little.

If the data driving device 110 may supply the data current (Id) by rapidly increasing it, the data voltage (Vd) may be supplied to the desired level within a short period of time. On the other hand, if the data driving device 110 cannot supply the data current (Id) by rapidly increasing it, it may take a relatively long time for the data voltage (Vd) to be supplied to the desired level. Accordingly, the data driving device 110 may be developed in a form that may rapidly increase the data current (Id). However, if the data current (Id) increases rapidly, a problem may occur in which the size of noise appearing in the circuit increases.

The data driving device 110 and other devices may share a ground pattern (GND). For example, the power management device 150, the data driving device 110, and the display panel 120 may share a ground pattern (GND). According to this sharing, the ground noise appearing in the data drive device 110 may affect other devices as well. And, this ground noise may cause malfunction of other devices or cause poor image quality.

The aforementioned data current (Id) is not the only one that generates ground noise. The data drive device 110 may convert a digital signal into an analog signal every horizontal time, but since the conversion is performed in a short moment, noise may also occur at this time, and this noise may affect the data voltage (Vd).

The data drive device according to one aspect applies a technology that minimizes the occurrence and propagation of this noise.

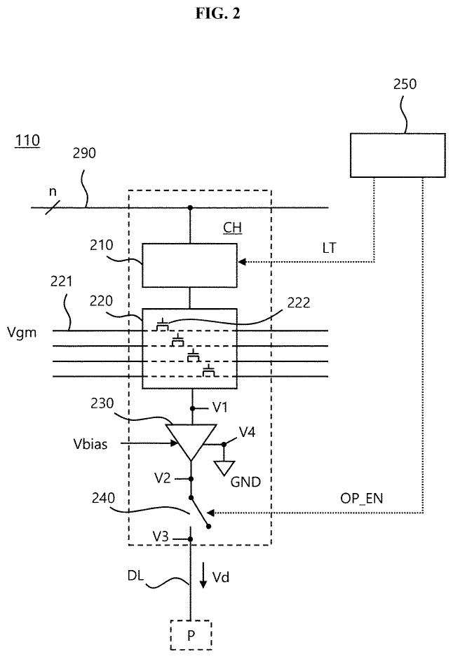

FIG. 2 is a configuration diagram of the data drive device according to one aspect.

Referring to FIG. 2, the data drive device 110 may include a timing control circuit 250, a channel circuit (CH), and a data bus line 290.

The data bus line 290 may be composed of n lines (n is a natural number). The data bus line 290 and the channel circuit (CH) are connected, and the channel circuit (CH) may latch pixel image data transmitted to the data bus line 290 one by one per horizontal time. Although only one channel circuit (CH) is illustrated in the drawing, the data driving device 110 may have multiple channel circuits (CH), and each channel circuit (CH) may have a shift register, so that each channel circuit (CH) may sequentially latch pixel image data transmitted to the data bus line 290.

The channel circuit (CH) may include a latch circuit 210, a digital-to-analog converting circuit 220, a buffer circuit 230, and an output switch 240, etc.

The latch circuit 210 may store pixel image data received through the data bus line 290.

The latch circuit 210 may have two latches inside. The first latch may store pixel image data to be output at the next horizontal time, and the second latch may store pixel image data to be output at the current horizontal time. When the next horizontal time comes, the pixel image data to be output at the next horizontal time may be stored in the first latch, and the pixel image data stored in the first latch may be moved to and stored in the second latch.

The output timing of the latch circuit 210 may be determined according to the latch output signal (LT) generated from the timing control circuit 250 for each horizontal time. The latch output signal (LT) may be synchronized with the horizontal synchronization signal. Alternatively, the latch output signal (LT) may be a signal having a different phase from the horizontal synchronization signal but the same period length.

The latch circuit 210 may output pixel image data stored in the latch circuit 210 in the form of a digital signal at each horizontal time according to the latch output signal (LT). Then, this digital signal may be transmitted to the digital-to-analog converting circuit 220.

The digital-to-analog converting circuit 220 may convert a digital signal into an analog signal using gamma voltages (Vgm).

The digital-to-analog converting circuit 220 has a plurality of gamma voltage lines 221 arranged, and a gamma voltage (Vgm) corresponding to a different grayscale value may be formed in each gamma voltage line 221. For example, a first gamma voltage corresponding to a first grayscale value may be formed in a first gamma voltage line, and a second gamma voltage corresponding to a second grayscale value may be formed in a second gamma voltage line.

The digital-to-analog converting circuit 220 may include a plurality of switches 222 each connected to a plurality of gamma voltages (Vgm). The plurality of switches 222 may control the connection between each gamma voltage line 221 and the output of the digital-to-analog converting circuit 220.

The digital-to-analog converting circuit 220 may convert a digital signal into an analog signal by selecting one of the plurality of gamma voltages (Vgm) using the plurality of switches 222.

The plurality of switches 222 may be turned on/off according to the digital signal. In addition, one of the plurality of gamma voltages (Vgm) may be determined as an analog signal according to the on/off state of the plurality of switches 222.

The plurality of switches 222 may change the on/off state whenever a new digital signal is received. For example, a digital signal may be output from a latch circuit 210 according to a latch output signal, and at the time when such a digital signal is output, the on/off state of multiple switches 222 may be changed.

When a relatively large amount of power is consumed at the time when the multiple switches 222 change the on/off state, noise may occur in the output of the digital-to-analog converting circuit 222.

The buffer circuit 230 may include an input switch to block the propagation of such noise.

The buffer circuit 230 may include an input switch that controls the connection with the digital-to-analog converting circuit 220, and may amplify an analog signal output from the digital-to-analog converting circuit 220 to generate a data voltage (Vd) for driving a pixel (P).

The buffer circuit 230 may turn off the input switch for a predetermined first time so that the analog signal is input to the buffer circuit 230 with a delay of the first time.

When the timing control circuit 250 outputs a latch output signal (LT), a digital signal is output from the latch circuit 210, and at the time when the digital signal is output, the switches 222 of the digital-to-analog converting circuit 220 change their on/off state. Then, the aforementioned noise occurs at the time when the switches 222 change their on/off state, and the input switch of the buffer circuit 230 may block the propagation of the noise generated in the digital-to-analog converting circuit 220 by turning off for the first time from the time when the switches 222 of the digital-to-analog converting circuit 220 change their on/off state. In another aspect, the input switch of the buffer circuit 230 may block the propagation of noise by being turned off for a first time from the time when the digital signal is output from the latch circuit 210. Or, the input switch of the buffer circuit 230 may block the propagation of noise by being turned off for a first time from the time when the analog signal is output from the digital-to-analog converting circuit 220.

The buffer circuit 230 may receive a bias voltage (Vbias) and amplify an analog signal by using the bias voltage (Vbias). However, if the buffer circuit 230 uses the bias current too rapidly during this amplification process, it may generate noise with a large intensity in the ground (GND).

The buffer circuit 230, the latch circuit 210, and the digital-to-analog converting circuit 220 may share the ground (GND), and if the aforementioned noise occurs, the noise may be transmitted through the shared ground (GND) and cause additional problems.

The data driving device 110 may include an output switch 240 to minimize the transmission of noise.

The output switch 240 may control the connection between the data line (DL) connected to the pixel (P) and the buffer circuit 230.

The timing control circuit 250 may generate an output enable signal (OP_EN) that controls the on/off of the output switch 240. The output enable signal (OP_EN) may turn off the output switch 240 at part of the horizontal time, and may turn on the output switch 240 during the remaining time. For example, the timing control circuit 250 may turn off the output switch 240 during a second time from the time when the digital signal is output through the output enable signal (OP_EN). From another perspective, the timing control circuit 250 may turn off the output switch 240 during a second time from the time when the latch output signal (LT) is generated through the output enable signal (OP_EN).

The output switch 240 and the input switch of the aforementioned buffer circuit 230 may operate in synchronization. When the output switch 240 is turned off, the input switch of the buffer circuit 230 may also be turned off, and when the output switch 240 is turned on, the input switch of the buffer circuit 230 may also be turned on.

The timing control circuit 250 may have different waveforms of the output enable signal (OP_EN) depending on the mode. In the first mode, the timing control circuit 250 may not transmit the output enable signal (OP_EN) or may keep the output switch 240 turned on continuously for the horizontal time through a waveform of a constant voltage level. In this first mode, the input switch of the buffer circuit 230 may also be kept on continuously for the horizontal time. And, in the second mode, the timing control circuit 250 may transmit an output enable signal (OP_EN) that turns off the output switch 240 for some time during the horizontal time as described above. In this second mode, the input switch of the buffer circuit 230 may also be turned off for some time during the horizontal time.

The buffer circuit 230 may further include an output connection switch that operates on/off in the opposite direction to the input switch. The output connection switch may maintain the input/output of the buffer circuit 230 at the voltage of the data line (DL) during the time when the input switch is turned off.

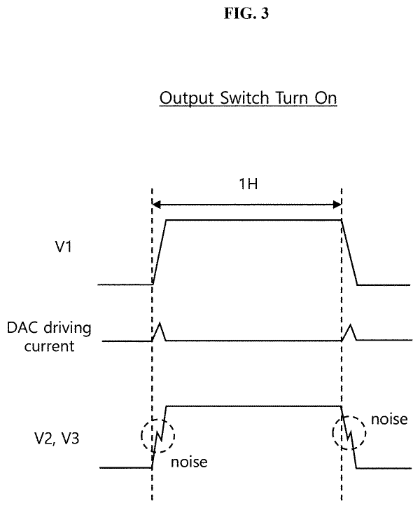

FIG. 3 is a drawing for explaining noise that may appear in the first mode.

The waveforms shown in FIG. 3 are waveforms of the output voltage of the digital-to-analog converting circuit (see V1 in FIG. 2), the driving current supplied to the digital-to-analog converting circuit (DAC), the voltage of the terminal on the buffer circuit side from the output switch (see V2 in FIG. 2), and the voltage of the terminal on the pixel side from the output switch (see V3 in FIG. 2) in the first mode.

Referring to FIG. 3, when a new horizontal time (1H) starts and the digital-to-analog converting circuit (DAC) converts a digital signal into an analog signal, it may be seen that noise occurs in the driving current of the digital-to-analog converting circuit (DAC) depending on the change in the state of the switches.

In the first mode, the output switch may be turned on constantly, and accordingly, it may be seen that the noise of the digital-to-analog converting circuit (DAC) affects the voltage (V2) corresponding to the output of the buffer circuit and the pixel-side terminal voltage (V3) of the output switch.

Since the noise appearing in the pixel-side terminal voltage (V3) of the output switch is also transmitted to the pixel, the problem of the image quality deteriorating due to this noise may occur in the first mode.

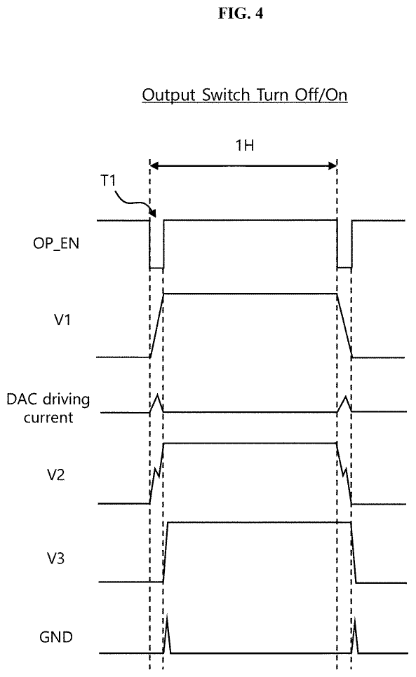

FIG. 4 is a drawing for explaining noise that may occur when there is no input switch in the second mode.

Referring to FIG. 4, when a new horizontal time (1H) starts and the digital-to-analog converting circuit (DAC) converts a digital signal into an analog signal, noise may occur in the driving current of the digital-to-analog converting circuit (DAC) depending on the change in the state of the switches.

To block this noise from being transmitted to the pixel, the output switch may be turned off during the first time (T1) through the output enable signal (OP_EN).

Referring to FIG. 4, as the output switch is turned off, it may be confirmed that noise of the digital-to-analog converting circuit (DAC) appears in the voltage (V2) corresponding to the output of the buffer circuit, but does not appear in the pixel-side terminal voltage (V3) of the output switch.

However, if the output of the buffer circuit is suddenly transferred to the pixel after the first time (T1), new noise may occur in the ground. The output switch is turned off during the first time (T1), and at this time, the buffer circuit generates output in a no-load state. If the output switch is suddenly turned on in this state, the output current of the buffer circuit may rapidly increase as it is supplied to the parasitic capacitor. This phenomenon is also called the inrush current phenomenon.

If new noise occurs in the ground due to this inrush current, fluctuations may also occur in other devices sharing the ground, causing problems such as image quality. To solve this problem, the buffer circuit may include an input switch.

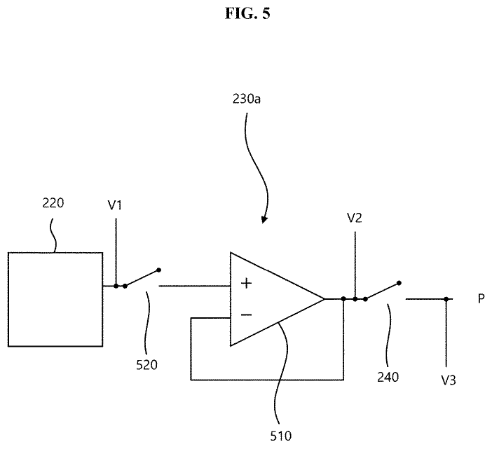

FIG. 5 is a drawing illustrating a first example of a buffer circuit according to one aspect.

Referring to FIG. 5, the buffer circuit 230a may include an input switch 520, an amplifier 510, etc.

The input switch 520 may be connected to the output of the digital-to-analog converting circuit 220. The input switch 520 may be turned off for a first time after a new horizontal time starts. According to this operation, an analog signal output from the digital-to-analog converting circuit 220 may be delayed by the first time and transmitted to the amplifier 510. The digital-to-analog converting circuit may complete the conversion operation for the digital signal into an analog signal before the analog signal is input to the buffer circuit 230a—for example, before the first time ends.

One input terminal of the amplifier 510—for example, a minus input terminal—may be electrically connected to the output terminal. According to this connection relationship, the amplifier 510 may function as a buffer.

The input switch 520 may control the electrical connection between the output of the digital-to-analog converting circuit 220 and another input terminal of the amplifier 510-for example, the plus input terminal.

The input switch 520 may operate in synchronization with the output switch 240.

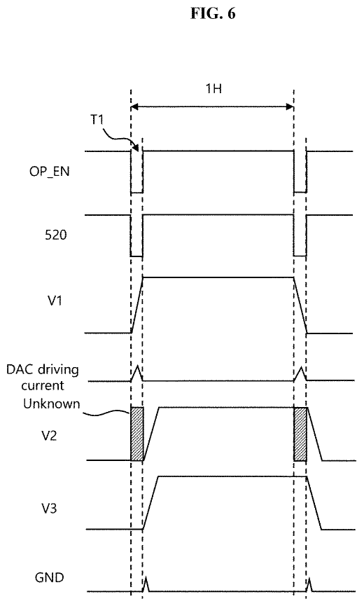

FIG. 6 is a diagram illustrating the main waveforms of the first example illustrated in FIG. 5.

Referring to FIG. 6, a new horizontal time (1H) starts, and the digital-to-analog converting circuit (DAC) may convert a digital signal into an analog signal according to the latch output signal, and at this time, noise may appear in the output of the digital-to-analog converting circuit (DAC).

To block the propagation of such noise, the output enable signal (OP_EN) may turn off the output switch during the first time (T1) after a new horizontal time (1H) starts. In addition, the input switch may also be turned off during the first time (T1). Depending on the aspect, there may be a difference between the turn-off time of the output switch and the turn-off time of the input switch.

Since the input switch is turned off during the first time (T1), the output noise of the digital-to-analog converting circuit (DAC) is not transmitted to the buffer circuit.

After the first time (T1) has elapsed, when the input switch and the output switch are turned on, the buffer circuit starts a signal amplification operation and supplies a data voltage to the pixel. At this time, since the output current is controlled to a certain size or less in the signal amplification operation of the buffer circuit, the ground noise does not appear significantly.

Meanwhile, in the first example, the input of the amplifier may become unknown while the input switch is turned off. To prevent this state, the buffer circuit may further include an output connection switch.

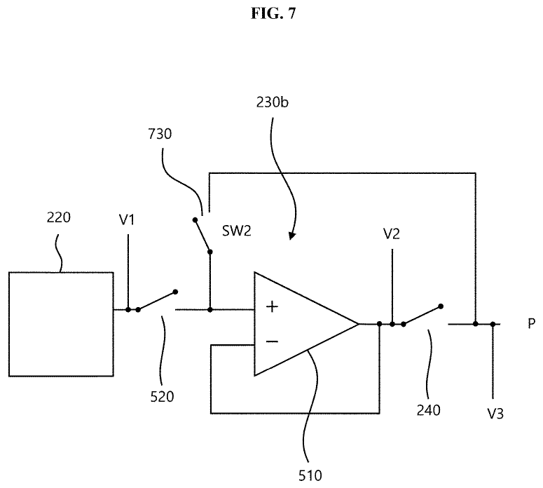

FIG. 7 is a diagram illustrating a second example of a buffer circuit according to one aspect.

Referring to FIG. 7, the buffer circuit 230b may include an input switch 520, an amplifier 510, and an output connection switch 730, etc.

The input switch 520 may be connected to the output of the digital-to-analog converting circuit 220. The input switch 520 may be turned off for a first time after a new horizontal time starts. According to this operation, an analog signal output from the digital-to-analog converting circuit 220 may be delayed by the first time and transmitted to the amplifier 510. The digital-to-analog converting circuit may complete the conversion operation for the digital signal into the analog signal before the analog signal is input to the buffer circuit 230a—for example, before the first time ends.

One input terminal of the amplifier 510—for example, a minus input terminal-may be electrically connected to the output terminal. Depending on this connection relationship, the amplifier 510 may function as a buffer.

The input switch 520 may control the electrical connection between the output of the digital-to-analog converting circuit 220 and another input terminal of the amplifier 510-for example, a plus input terminal.

The input switch 520 may operate in synchronization with the output switch 240.

The output connection switch 730 may control the electrical connection between another input terminal of the amplifier 510—for example, a plus input terminal—and the pixel side terminal of the output switch 240.

The output connection switch 730 may operate in the opposite direction to the input switch 520. The output connection switch 730 may be turned on during the time when the input switch 520 is turned off. Accordingly, the other input terminal of the amplifier 510 may be maintained at the same voltage as the voltage formed on the data line without floating.

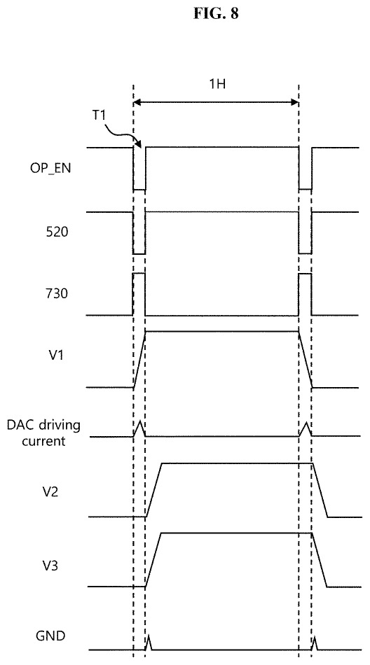

FIG. 8 is a diagram illustrating the main waveform of the second example illustrated in FIG. 7.

Referring to FIG. 8, a new horizontal time (1H) begins, and a digital-to-analog converting circuit (DAC) may convert a digital signal into an analog signal according to a latch output signal, and at this time, noise may appear in the output of the digital-to-analog converting circuit (DAC).

To block the propagation of such noise, the output enable signal (OP_EN) may turn off the output switch during the first time (T1) after the new horizontal time (1H) begins. And, the input switch may also be turned off during the first time (T1).

Since the input switch is turned off during the first time (T1), the output noise of the digital-to-analog converting circuit (DAC) is not transmitted to the buffer circuit.

After the first time (T1) has elapsed, when the input switch and the output switch are turned on, the buffer circuit starts a signal amplification operation and supplies the data voltage to the pixel. At this time, since the output current is controlled to a certain size or less in the signal amplification operation of the buffer circuit, the ground noise does not appear significantly.

Meanwhile, when the input switch is turned off during the first time (T1), the output connection switch is turned on, so that the buffer circuit side terminal of the output switch may maintain a stable state without floating.

As described above, according to this aspect, the occurrence of noise due to instantaneous power consumption may be minimized or the intensity of such noise may be reduced. In addition, according to this aspect, the propagation of such noise may be blocked or minimized. In addition, according to this aspect, the influence of such noise may be minimized, thereby minimizing defects in the display device, particularly, defects in image quality.

1. A data driving device comprising:
a latch circuit configured to store pixel image data;
a digital-to-analog converting circuit configured to convert a digital signal corresponding to the pixel image data into an analog signal;
a buffer circuit including an input switch controlling connection with the digital-to-analog converting circuit and configured to transmit the analog signal to a pixel; and
an output switch configured to control connection between a data line connected to the pixel and the buffer circuit.

2. The data driving device according to claim 1, wherein the input switch is turned off for a first time period to delay the analog signal by the first time period and input the delayed analog signal to the buffer circuit.

3. The data driving device according to claim 2, further comprising:
a timing control circuit configured to generate a latch output signal at each horizontal time,
wherein the digital signal is output from the latch circuit according to the latch output signal,
wherein the input switch is turned off for the first time period from the time when the digital signal is output.

4. The data driving device according to claim 3, wherein the timing control circuit is further configured to generate an output enable signal that controls on/off of the output switch,
wherein the output switch is turned off for the first time period from the time when the digital signal is output according to the output enable signal.

5. The data driving device according to claim 2, wherein the input switch and the output switch operate in synchronization.

6. The data driving device according to claim 1, wherein the digital-to-analog converting circuit includes a plurality of switches each connected to a plurality of gamma voltages,
wherein on/off of the plurality of switches is determined according to the digital signal,
wherein one of the plurality of gamma voltages is determined as the analog signal according to on/off state of the plurality of switches.

7. The data driving device according to claim 1, wherein the latch circuit, the digital-to-analog converting circuit and the buffer circuit share a ground.)

8. The data driving device according to claim 1, wherein a parasitic capacitor is formed on the data line,
wherein the output switch, when turned off, is configured to release a connection between the parasitic capacitor formed on the data line and the buffer circuit.

9. The data driving device according to claim 1, wherein the input switch is,
in a first mode, continuously turned on during the horizontal time, and
in a second mode, turned off during part of the horizontal time.

10. The data driving device according to claim 9, wherein the buffer circuit further includes an output connection switch that operates on/off in a manner opposite to the on/off of the input switch,
wherein the output connection switch is configured to maintain the input/output of the buffer circuit at the voltage of the data line during the time when the input switch is turned off.

11. A data driving apparatus comprising:
a digital-to-analog converting circuit configured to convert a digital signal for a grayscale value into an analog signal for driving a pixel; and
a buffer circuit configured to delay the analog signal by a predetermined time and amplify the analog signal delayed by the predetermined time and transmit the amplified analog signal to the pixel.

12. The data driving device according to claim 11, wherein the buffer circuit includes an input switch connected to an output of the digital-to-analog converting circuit,
wherein the input switch is turned off for a predetermined first time period to delay the analog signal by the first time period.

13. The data driving device according to claim 12, wherein the buffer circuit includes an amplifier having one input terminal electrically connected to an output terminal,
wherein the input switch is configured to control an electrical connection between the output of the digital-to-analog converting circuit and another input terminal of the amplifier.

14. The data driving device according to claim 11, further comprising:
an output switch configured to control an electrical connection between the output of the buffer circuit and the pixel,
wherein the output switch is turned off for a predetermined second time period to delay the analog signal by the second time period and supply the delayed analog signal to the pixel.

15. The data driving device according to claim 14, wherein the buffer circuit includes an input switch that controls connection with the output of the digital-to-analog converting circuit,
wherein the input switch operates in synchronization with the output switch.

16. The data driving device according to claim 14, wherein the buffer circuit includes:
an amplifier having one input terminal electrically connected to an output terminal,
an input switch configured to control electrical connection between the output of the digital-to-analog converting circuit and another input terminal of the amplifier, and
an output connection switch configured to control electrical connection between the other input terminal of the amplifier and a pixel-side terminal of the output switch.

17. The data driving device according to claim 16, wherein the output connection switch is turned on during a time when the input switch is turned off.

18. The data driving device according to claim 11, wherein the buffer circuit is configured to delay the analog signal for a predetermined first time and receives the delayed analog signal,
wherein the digital-to-analog converting circuit is configured to complete the conversion operation for the digital signal into the analog signal before the analog signal is input to the buffer circuit.

19. The data driving device according to claim 18, wherein the digital-to-analog converting circuit is configured to convert the digital signal into the analog signal by selecting one of the plurality of gamma voltages using a plurality of switches.

20. The data driving device according to claim 11, wherein the digital-to-analog converting circuit and the buffer circuit are connected with a ground.
